(19) United States
(12) Patent Application Publication
(10) Pub. No.: US 2023/0250905 A1
(43) Pub. Date: Aug. 10, 2023

(54) PIPE FLANGE CONNECTION SYSTEM WITH STATIC SEAL

(71) Applicant: Freudenberg Oil & Gas, LLC, Houston, TX (US)

(72) Inventors: David ROBERTSON, Tjodalyng (NO); Przemyslaw LUTKIEWICZ, Drammen (NO)

(21) Appl. No.: 17/667,750

(22) Filed: Feb. 9, 2022

(51) Int. Cl. F16L 23/20; F16L 23/02

(52) U.S. Cl. CPC F16L 23/20; F16L 23/02

(57) ABSTRACT

A pipe flange connection system includes a first pipe flange member and a second pipe flange member each having a bore extending therethrough and a flange section with a plurality of bolt holes spaced circumferentially around the flange section. Each flange section including an opposing face surface with an annular seal groove surrounding the bore. A plurality of bolts are disposed in the bolt holes for securing the first pipe flange member to the second pipe flange member. An annular metal seal ring is disposed between the first and second pipe flange members and having an H-shaped cross-section including a center bar portion and a first pair of radially spaced inner and outer lips extending in a first axial direction from the center bar portion and a second pair of radially spaced inner and outer lips extending in a second axial direction from the center bar portion.

### FIELD

The present disclosure relates to a pipe flange connection system with static seal.

### BACKGROUND

This section provides background information related to the present disclosure which is not necessarily prior art.

Pipe flange connection systems are utilized for connecting pipes that transport pressurized fluids and gasses. It is desirable to provide an improved seal for pipe flange connection systems that resist leakage at high pressures.

### SUMMARY

This section provides a general summary of the disclosure, and is not a comprehensive disclosure of its full scope or all of its features.

A pipe flange connection system includes a first pipe flange member and a second pipe flange member each having a bore extending therethrough and a flange section with a plurality of bolt holes spaced circumferentially around the flange section. Each flange section including an opposing face surface with an annular seal groove surrounding the bore, the annular seal groove including a pair of sidewalls and a groove bottom. A plurality of bolts disposed in the plurality of bolt holes for securing the first pipe flange member to the second pipe flange member. An annular metal seal ring disposed between the first pipe flange member and the second pipe flange member and having an H-shaped cross-section including a center bar portion and a first pair of radially spaced inner and outer lips extending in a first axial direction from the center bar portion and a second pair of radially spaced inner and outer lips extending in a second axial direction from the center bar portion. The first pair of radially spaced inner and outer lips being received in the annular seal groove of the first pipe flange member with each of the first pair of radially spaced inner and outer lips engaging a respective sidewall of the annular seal groove of the first pipe flange. The second pair of radially spaced inner and outer lips being received in the annular seal groove of the second pipe flange member with each of the second pair of radially spaced inner and outer lips engaging a respective sidewall of the annular seal groove of the second pipe flange, each of the first pair of radially spaced inner and outer lips and the second pair of radially spaced inner and outer lips having a thickness that gradually tapers toward a free end.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional perspective view of flange members according to the principles of the present disclosure;

FIG. 2 is a partial cross-sectional view of the flange member shown in FIG. 1;

FIG. 3 is a bottom plan view of the flange member shown in FIG. 1;

FIG. 4 is a cross-sectional view of an annular seal ring disposed between a pair of flange members according to the principles of the present disclosure;

FIG. 5 is a cross-sectional view of the annular seal ring according to the principles of the present disclosure; and

FIG. 6 is a cross-sectional view of the annular seal ring taken along a bolt hole through a center bar portion of the seal ring.

Corresponding reference numerals indicate corresponding parts throughout the several views of the drawings.

### DETAILED DESCRIPTION

Example embodiments will now be described more fully with reference to the accompanying drawings.

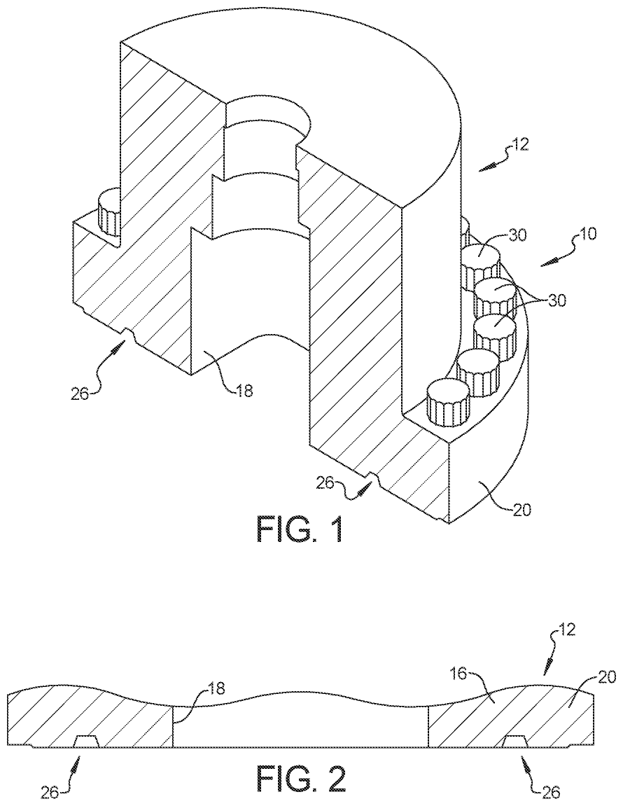

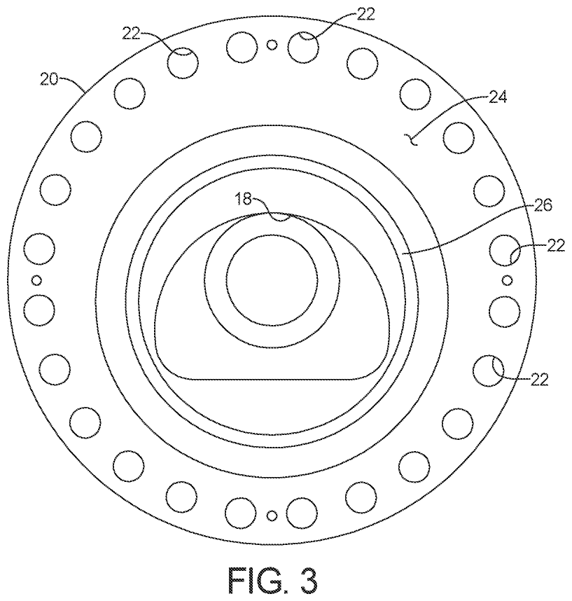

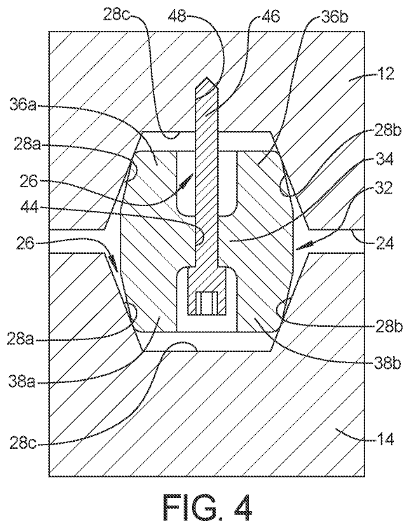

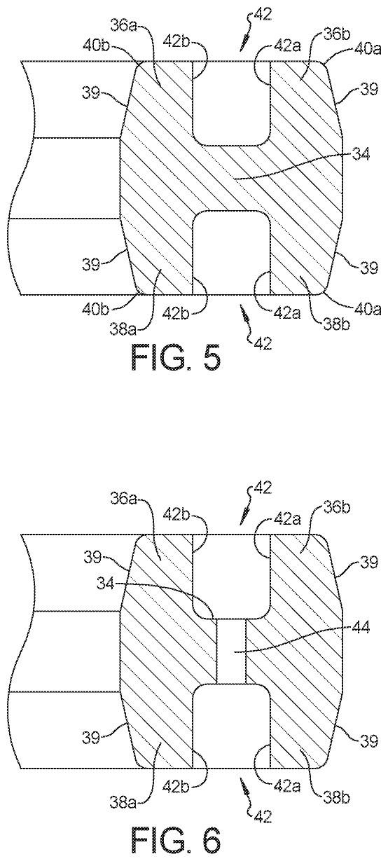

With reference to FIGS. 1-6, a pipe flange connection system 10 according to the principles of the present disclosure will now be described. FIG. 1 shows a cross-sectional perspective view of a first pipe flange member 12 which is connected to a similar or identical second pipe flange member 14, as shown in FIG. 4. With reference to FIG. 1 each pipe flange member 12, 14 includes a body 16 having a bore 18 extending therethrough. The body 16 includes a flange section 20 with a plurality of bolt holes 22 spaced circumferentially around the flange section 20. Each flange section 20 includes an opposing face surface 24 with a recessed annular seal groove 26 surrounding the bore 18. The annular seal groove 26 includes a pair of sidewalls 28a, 28b and a groove bottom 28c.

A plurality of bolts to are disposed in the plurality of bolt holes 22 for securing the first pipe flange member 12 to the second pipe flange member 14. The plurality of bolts 30 can be threaded into the threaded bolt holes 22 in the flange section 20 of the second pipe flange member 14 or alternatively can receive nuts thereon for securing the second pipe flange member 14 to the first pipe flange member 12.

An annular metal seal ring 32 is disposed within the recessed annular seal grooves 26 between the first pipe flange member 12 and the second pipe flange member 14. The annular metal seal ring 32 includes an H-shaped cross-section including a center bar portion 34 and a first pair of radially spaced inner and outer lips 36a, 36b extending in a first axial direction from the center bar portion 34 and a second pair of radially spaced inner and outer lips 38a, 38b extending in a second (opposite) axial direction from the center bar portion 34.

As best shown in FIG. 4, the first pair of radially spaced inner and outer lips 36a, 36b are received in the annular seal groove 26 of the first pipe flange member 12 with each of the first pair of radially spaced inner and outer lips 36a, 36b engaging a respective sidewall 28a, 28b of the annular seal groove 28 of the first pipe flange 12. The second pair of radially spaced inner and outer lips 38a, 38b being received in the annular seal groove 28 of the second pipe flange member 14 with each of the second pair of radially spaced inner and outer lips 38a, 38b engaging a respective sidewall 28a, 28b of the annular seal groove 26 of the second pipe flange 14. The sidewalls 28a, 28b can be provided with a smooth surface finish. Each of the first pair of radially spaced inner and outer lips 36a, 36b and the second pair of radially spaced inner and outer lips 38a, 38b have an outboard and an inboard surface 39, respectively that gradually tapers toward a free end so that the lips have a reducing thickness toward the free end. An outboard edge 40a and an inboard edge 40b of the first pair of radially spaced inner and outer lips 36a, 36b and the second pair of radially spaced inner and outer lips 38a, 38b, respectively, are radiused. The leading radius of the outboard edge 40a and the inboard edge 40b ensures no sharp point which could cause an issue during installation. The first pair of radially spaced inner and outer lips 36a, 36b and the second pair of radially spaced inner and outer lips 38a, 38b each define an annular groove 42 therebetween with generally parallel outer and inner sidewalls 42a, 42b, respectively.

The seal ring 32 is elastically deformed in the seat which creates a radial sealing force. This is achieved by the radially spaced inner and outer lips 36a, 36b and 38a, 38b bending towards the midline of the cross section as the flange members 12, 14 are pulled together. Only a very small percentage of the bolt pre-load is required to maintain an effective seal. The seal ring 32 can be used multiple times. The material needs to be as strong as possible to give the required spring like qualities. The higher the yield strength, the more time the seal ring 32 can possibly be re-used.

As show in FIGS. 4 and 6, the center bar portion 34 of the seal ring includes a plurality of circumferentially spaced apertures 44 therein that receive retaining fasteners 46 that are engaged with a threaded bore 48 in the first pipe flange member 12 in order to secure the seal ring 32 to the first pipe flange member 12 during assembly with the second pipe flange member 14. The retaining fasteners 46 are an option to help aid assembly.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A pipe flange connection system, comprising:
a first pipe flange member and a second pipe flange member each having a bore extending therethrough and a flange section with a plurality of bolt holes spaced circumferentially around the flange section and each flange section including an opposing face surface with an annular seal groove surrounding the bore, the annular seal groove including a pair of sidewalls and a groove bottom;
a plurality of bolts disposed in the plurality of bolt holes for securing the first pipe flange member to the second pipe flange member;
an annular metal seal ring disposed between the first pipe flange member and the second pipe flange member and having an H-shaped cross-section including a center bar portion and a first pair of radially spaced inner and outer lips extending in a first axial direction from the center bar portion and a second pair of radially spaced inner and outer lips extending in a second axial direction from the center bar portion, the first pair of radially spaced inner and outer lips being received in the annular seal groove of the first pipe flange member with each of the first pair of radially spaced inner and outer lips engaging a respective sidewall of the annular seal groove of the first pipe flange, the second pair of radially spaced inner and outer lips being received in the annular seal groove of the second pipe flange member with each of the second pair of radially spaced inner and outer lips engaging a respective sidewall of the annular seal groove of the second pipe flange, each of the first pair of radially spaced inner and outer lips and the second pair of radially spaced inner and outer lips having a thickness that gradually tapers toward a free end.

2. The pipe flange connection system according to claim 1, wherein the center bar portion includes a plurality of apertures therein that receive fasteners that are engaged with one of the first and second pipe flange members.

3. The pipe flange connection system according to claim 1, wherein the first pair of radially spaced inner and outer lips and the second pair of radially spaced inner and outer lips have radiused inboard and outboard edges, respectively.
